(19) United States
(12) Patent Application Publication
(10) Pub. No.: US 2012/0209923 A1
(43) Pub. Date: Aug. 16, 2012

(54) SYSTEMS AND METHODS FOR REGULATING ACCESS TO RESOURCES AT APPLICATION RUN TIME

(75) Inventors: Gaurav Mathur, Mountain View, CA (US); Tom Moss, Los Altos, CA (US); Michael Chan, San Francisco, CA (US)

(73) Assignee: THREE LAWS MOBILITY, INC., Mountain View, CA (US)

(21) Appl. No.: 13/026,222

(22) Filed: Feb. 12, 2011

(51) Int. Cl. G06F 15/16

(52) U.S. Cl. 709/206; 709/229

(57) ABSTRACT

Systems and methods are provided for regulating access to resources at application run-time. A permissions application is invoked. The permissions application accesses an information store comprising a plurality of permissions. Each such permission is associated with a corresponding resource in a plurality of device resources. The information store specifies which applications have permission to access which device resources. An application is executed on the device and makes a request for a resource while the application is executing. Responsive to the request, the permissions application determines whether the application has run-time access permission to use the resource. When the application has run-time access permission to use the resource, it is granted run-time access to the resource. When the application does not have run-time access permission to use the resource, it is not granted run-time access to the resource but is permitted to continue executing on the device without the requested resource.

### 1. FIELD OF THE DISCLOSURE

The present application relates to systems and methods for regulating resources gated by permissions at application run-time. Applications are permitted to execute while access to certain resources is denied at runtime based on the provided configuration.

### 2. BACKGROUND

Before an Android application is installed, or created for that matter, the application developer specifies a set of permissions that the application needs at run-time to actually run. This is specified in the AndroidManifest.xml file that appears in the root directory of the Android application. A permission is a restriction limiting access to a resource, such as part of the code or data on the device. The limitation is imposed to protect critical data and code that could be misused to distort or damage the user experience. Each permission is identified by a unique label. Often the label indicates the resource that is restricted. For example, here are some permissions defined by Android:

android.permission.CALL_EMERGENCY_NUMBERS

android.permission.READ_OWNER_DATA

android.permission.SET_WALLPAPER

android.permission.DEVICE_POWER

In the order listed, these four permissions respectively restrict the resource of calling emergency numbers, reading owner data, setting the display wallpaper, and monitoring device power.

In the case of an application that can download information from the Internet, when the application is created, the application developer specifies that the application requires Internet access, storage, and any other permissions that the application may require. Then, a user installs the application. During the installation, the user is presented with the full set of permissions that the application requires. In typical instances, this set of permissions may range from one or two permissions to twenty-five or more different permissions. By and large, users bypass this permissions presentation. This may be because the application is installed for them, the user is not challenged to approve access to the requested permissions, or the user simply approves the set of permissions without considering whether sensitive data will be compromised.

From a user perspective, the installation of applications is not necessarily a concern. What is of concern is protecting user data. For example, consider the case of a salesman who has a contact list that is very important. What is not desired is for a nefarious application to be installed that copies the contact list and uploads it to some remote server without the salesman's permission.

Given the above importance of the above identified objectives, what are needed in the art are improved systems and methods for addressing security problems associated with the use of applications on devices.

### 3. SUMMARY

The present disclosure provides systems and methods that address the above-identified objectives. For any given permission available in the Android operating system or any custom developer-defined permission, a white list of approved applications, or the logical equivalent thereof, is provided. For instance, in the case of accessing a contact list application, the white list specifies the applications that have permission to access the contact list application. If an application is not on the white list for this permission, it is not granted access to the contact list application and therefore cannot access the contact list held by the Android device. While any application can be freely installed on the mobile device and request access to the contact list at runtime, only those applications on the white list will actually be granted such access.

In the systems and methods of the present disclosure, for each given resource provided by a device, there is a list of applications and, for each respective application in the list, whether the respective application is allowed access to the resource or not. So, for the example of the contact list application, there is a list of applications that are granted permission to access the contact list application.

In some embodiments, applications that do not have approval for a specific resource are simply not listed. In the example of the contact list application, any application not on the approved list for permission to access the contact list application is not granted access to the contact list, in such embodiments.

In one embodiment, the permissions that are granted to specific applications are specified as a set of rules. For example, the set of rules associated with the contact list application may have the form set forth in the following table.

| Rule | | | |
|---|---|---|---|
| Number | Resource | Application List | Permission |
| 1 | contact list | App₁, . . . , Appₙ | Allow access to the |
| | application | | contact list application |
| 2 | contact list | Any application other | Disallow access to the |
| | application | than App₁, . . . , Appₙ | contact list application |

Thus, rule 1 specifies which applications are allowed to access the contact list application and rule 2 specifies that any application not in rule 1 is not allowed to access the contact list application. The combination of rules 1 and 2 specifies that, for all applications, do not grant access to the contact list application unless the application is in the set of applications App₁, . . . , Appₙ. There is any number of logical ways in which the white list for a given resource may be stored and the example provided here is meant simply to illustrate one such way.

What is to be appreciated is not the format of the above-identified rules, but the fact that they are enforced at run-time. Such rules allow end users of devices complete flexibility to download any applications they want. The idea is premised on the principle that the environment a particular device is operating in when an application is downloaded is not of interest. Rather, what is of interest is the operating environment of the device at run-time. The forgoing set up provides an excellent compromise at the enterprise level because it allows device users to personalize their devices even if they are used in the workplace without compromising sensitive data or abusing resources.

In one embodiment, the systems and methods of the present disclosure work by adding a back door to the Android gatekeeper warehouse controller. The gatekeeper warehouse controller is responsible for installing applications on a device. In conventional Android device operation, when the gatekeeper warehouse controller installs an application, the permissions that the application requests are cataloged and presented to a user. This is because, in an Android system, every application is required to announce which permissions it desires when the application is being installed on the device. For example, if a newly installed application wants to access the contact list application (when the newly installed application is eventually run), this must be announced during application installation. The Android device user then makes the decision, given the set of permissions that the application requests, whether to allow the application to install or not. If the device user decides that the requested permissions are too extensive, the application is rejected and not installed.

In the present systems and methods, such an all or nothing approach is not required. An application is allowed to install regardless of what permission requests it announces during installation. Of course, the user may reject the application outright. Assuming the user does not reject the application, after the gatekeeper warehouse controller has finished the application installation process, the white list is consulted to verify that the application is allowed to have each of the permissions that the application requested. If the application requests a permission that it is not allowed to have, it is not granted the resource associated with the denied permission at run-time. The application is still allowed to run without the denied resource, provided the application was written in such a way that it is still executable without the denied resource. It will be appreciated that the systems and method of the present disclosure allow for something other than an all or nothing approach to resources. That is, the application may be granted some of the resources that it requests but denied others.

Advantageously, the systems and methods of the present disclosure allow an information technology administrator to enforce an application specific permission policy at the enterprise level at application run-time. This is done by installing a permissions application on each device under the responsibility of the information technology administrator. The permissions application acts when an application is executed. Upon execution of a given application on the device, the permissions application checks to see which resources the given application is permitted to use against a “white list” of resources and only allows the given application to use the resources on the white list even if it is the case that the given application was granted a denied resource by the gatekeeper warehouse controller during application installation. In this way, the question asked for each device is no longer which applications can be installed on such devices and which cannot but rather, for each respective application installed, what resources is the application granted at run-time. In this way, corporate data is secured even in instances where users are allowed to run personal applications on their devices.

The Android operating system defines several different resources, with each such respective resource having an associated permission to access the respective resource or not. The systems and methods of the present disclosure allow for the control, at a resource specific level, which applications may use each such resource and which may not. Exemplary resources that are defined in the Android operating system and therefore can be controlled include, but are not limited to, a contacts list, Wi-Fi connection, blue tooth access, screen access, and access to storage to name a few. Moreover, the Android operating system permits users to define resources and define the permissions to access such resources. For example, a sensitive company document, such as blueprints, business plans, or a catalog, can be defined as a custom resource and a unique permission to access this resource created. The permission can be, for example, “give permission to this defined resource to anyone that has the same signature as me”. The net effect of such a permission grant is that permission would be essentially only granted to the creator of the custom resource. Other examples include “do not grant permission to this custom resource to anyone” or “grant permission to this custom resource to everyone”. Then, using the systems and methods of the present disclosure, access to such custom resources is advantageously regulated on an application by application basis when such applications are executed in accordance with the custom permissions associated with each such custom resource.

The systems and methods of present disclosure are particularly advantageous because they remove the burden of screening the ever growing library of applications that can run on devices to determine which applications are “safe” to run on a device. Rather than screening batches of applications as they are released into the public domain on a daily basis, an IT administrator can instead focus on protecting device resources, whether such resources are custom resources defined by the IT administrator, resources defined by the device operating system through a permissions scheme (e.g., Android operating system), or some combination of the two. An end user is permitted to download any application desired and any such application is permitted to run and access any resources to which it has run-time permission to use. Thus, the systems and methods of the present disclosure allow an IT administrator or a manager of one or more devices to define (i) what is to be protected and (ii) who (which people, which applications) has access to such protected resources.

Without the systems and methods of the present disclosure, an IT administrator would be faced with either (i) the intractable problem of screening every possible application that can be run on devices to make sure they are “safe” or (ii) barring users from downloading and installing applications on corporate devices. Neither choice is tenable and the systems and methods of the present disclosure alleviate the need to pursue such untenable options.

A specific example of how the systems and methods of the present disclosure may be used arises in the case where there is a salesman that has an Android device. The salesman wishes to use a particular SALESFORCE.COM application which is known to require access to the contacts list application on the Android phone. The IT manager considers the salesman's request to install the application on the Android device. The IT manager is familiar with the requested SALESFORCE.COM application, knows that the application requires access to the contacts list application, and knows that the salesman needs the SALESFORCE.COM application to his job. So, the IT manager pushes a policy (white list) to the salesman's Android device to be enforced by the permissions application installed on the device. The policy is unique to this salesman's device and it grants the SALESFORCE.COM application permission to access the contacts list. That is, at runtime, the permissions application does not bar the SALESFORCE.COM application's request for access to the contacts list application. Further suppose that a malicious application is also installed on the salesman's device. Such an installation could be the result of accessing some website on the Internet or because the malicious application was masked as a useful application that was of interest to the salesman. Regardless of why installed, when the malicious application is executed and tries to access the contact list application, the permissions application does not allow the malicious application to access the contact list application even though the permissions application does allow the SALESFORCE.COM application running on the same device access to this resource. The malicious application is allowed to continue to run even though it was denied access to the contact list application, provided that the malicious application was written in such a manner that it does not terminate when it is denied the requested resource.

One type of resource that the systems and methods of the present disclosure can be used to control access to is installed applications. The example of the contact list application has already been described above. More precisely, when permission is granted to access the contact list application, what is granted is permission to interface with the contact application which, in turn, creates and manages the contact list. In the Android operating system, each application runs in its own sandbox such that other applications cannot directly access the files created by a particular application. What can be done, as in the case of the contact list, is to grant access to an application which created the desired data structure. Thus, in the systems and methods of the present disclosure, access to an application is one form of resource that can be controlled. So, any number of custom applications can be installed on an Android device and the systems and methods of the present application can be used to specify detailed rules on which applications can access such applications.

Using the systems and methods of the present disclosure, a custom application that creates and stores sensitive company data can be written. In of itself, the custom application is secure because the files created by the custom application (the sensitive company data) are in their own sandbox. No other applications can directly access this information. But suppose that the custom application lacks certain functionality that is possessed by a different application (e.g., a secondary application). In such a case, it is desired to grant the secondary application access to the custom application. In this way, the secondary application can access the data created by the custom application through the custom application. The systems and methods of the present disclosure can be used to define the custom application as a resource with a corresponding permission which grants access to the custom application. Then, only those applications that an administrator deems necessary or prudent to the custom application are granted access to the custom application. In this way, sensitive data of any nature can be protected using the systems and methods of the present disclosure. Further, it is not necessary to attempt to write a single custom application that handles all the functionality that is desired. Rather, sensitive data can be managed by a custom application and access can be granted to trusted secondary applications as needed.

Another example provides another way of viewing the advantages of the system and methods of the present disclosure. A corporation writes an application, foo, whose purpose is to always have the proprietary most up-to-date price list. Foo is installed on a set of Android devices which belongs to, or are controlled by, the corporation. Foo is now a resource by virtue of the fact that it is an application that is installed on the devices. This resource can be gated with a custom permission declaration. Certain programs are granted access to the custom price list by granting them permission to access the application foo. With this permission in hand, such programs can make queries of foo and obtain data from the application.

Still another application of the systems and methods of the present disclosure is to tightly gate the GPS resource of an Android device so that it is not possible for nefarious programs running on the Android device to exploit location information for some objective that is against the interests of the owner of the Android device. For instance, if Android devices are deployed to military personal, then the resources that are related to location identification could be gated (blocked) using the system and methods of the present disclosure to prevent programs from nefariously communicating troop location information to enemy combatants. At the same time, white listed applications could have access to such information. Resources relevant to this example in version 2.3 of the Android operating system (GOOGLE, Mountain View, Calif.) include the ACCESS_COARSE_LOCATION resource, which allows an application to access coarse (e.g., Cell-ID, WiFi) location and the ACCESS_FINE_LOCATION resource, which allows an application to access fine (e.g., GPS) location

### 4. BRIEF DESCRIPTION OF THE DRAWINGS

FIG. 1 illustrates a system in accordance with an embodiment of the present disclosure.

FIG. 2 illustrates a method in accordance with an embodiment of the present disclosure.

Like reference numerals refer to corresponding parts throughout the several views of the drawings.

### 5. DETAILED DESCRIPTION

The present disclosure details novel advances over known systems and methods for regulating access to resources at application run-time. In a particular embodiment, the permissions that gate resources are regulated at run-time in a mobile operating system at an enterprise level. Applications are permitted to execute even when such applications are denied access to certain requested resources gated by permissions that were not granted to such applications.

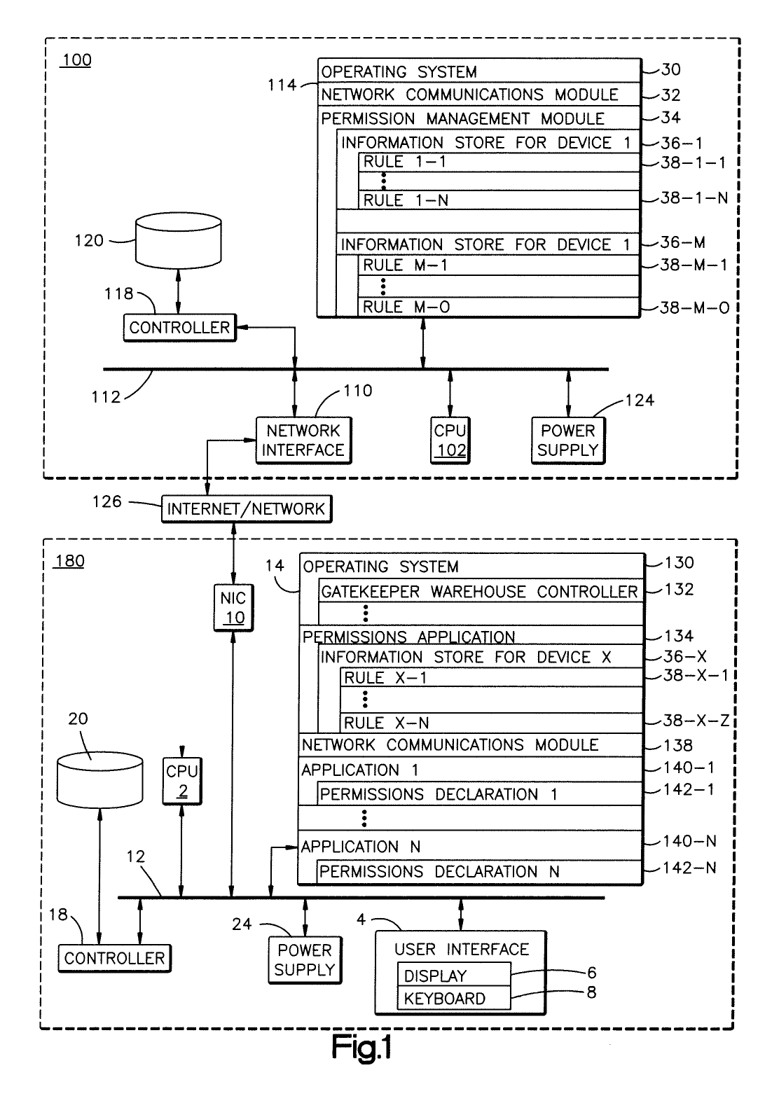

FIG. 1 illustrates the topology of an environment in accordance with the present disclosure. In the topology, there is a central device (e.g., server) 100 and one or more optional client devices 180. Of course, other topologies are possible, for instance, in some embodiments there are no client devices whereas in other embodiments there are two or more, five or more, ten or more or one hundred or more client devices 180. The exemplary topology shown in FIG. 1 merely serves to describe the features of an embodiment of the present disclosure in a manner that will be readily understood to one of skill in the art.

The central device 100 will typically have one or more processing units (CPU's) 102, a network or other communications interface 110, a memory 114, one or more magnetic disk storage and/or persistent devices 120 optionally accessed by one or more controllers 118, one or more communication busses 112 for interconnecting the aforementioned components, and a power supply 124 for powering the aforementioned components. Data in memory 114 can be seamlessly shared with non-volatile memory 120 using known computing techniques such as caching. Memory 114 and/or memory 120 can include mass storage that is remotely located with respect to the central processing unit(s) 102. In other words, some data stored in memory 114 and/or memory 120 may in fact be hosted on computers that are external to the central device 100 but that can be electronically accessed by the central device 100 over an Internet, intranet, or other form of network or electronic cable (illustrated as element 126 in FIG. 1) using network interface 110.

Memory 114 preferably stores:
an operating system 30 that includes procedures for handling various basic system services and for performing hardware dependent tasks;
a network communication module 32 that is used for connecting central device 100 to other computers such as clients 100; and
a permission management module 34 for controlling the resources of a plurality of devices 36.
   The permissions management module 34 has electronic access to a plurality of information stores 36. Each such information store 36 corresponds to a remote device 180. Moreover, each such information store 36 comprises a corresponding plurality of permissions associated with the remote device corresponding to the information store. Each of these permissions is associated with a corresponding resource associated with the remote device 180. Each information store 36 specifies, for each respective resource in the corresponding plurality of resources, which applications installed on the corresponding remote device 180 have run-time access permission to use the respective resource.

In some embodiments, an information store 36 that is associated with the remote device 180 comprises a plurality of rules 38, each rule in the plurality of rules corresponding to a resource in a plurality of resources and a permission in a plurality of permissions associated with the associated remote device 180. That is, each rule 38 specifies a resource and the corresponding permission that gates the resource. Each respective rule 38 in the plurality of rules specifies which applications 140, in a plurality of applications installed on the remote device 180, have run-time access to the resource corresponding to the respective rule 38.

The central device 100 is typically, though not necessarily, connected via Internet/network 126 to one or more remote devices 180. Typically this is a wireless connection. FIG. 1 illustrates the connection to only one such the remote device 180. In some embodiments there is only a single remote device 180. More typically, there are two or more remote devices 180, ten or more remote devices 180, one hundred or more remote devices 180, or even 1000 or more remote devices 180.

It is possible for a remote device 180 to be a smart phone, personal computer (e.g., desktop or laptop computer) tablet computer, or any form of mobile computing device. In typical embodiments the remote device 180 is operated under the Android operating system provided by GOOGLE (Mountain View, Calif.). Android is a mobile operating system initially developed by Android, Inc. Android was bought by GOOGLE in 2005. Android is based upon a modified version of the Linux kernel. Google and other members of the Open Handset Alliance collaborated to develop and release Android. The Android Open Source Project (AOSP) is tasked with the maintenance and further development of Android.

In typical embodiments, a remote device 180 comprises:
one or more processing units (CPU's) 2 such as an ARM processor, or other reduced instruction set processor, or a full instruction set processor;
a network or other communications interface 10;
a memory 14;
optionally, one or more magnetic disk storage and/or persistent storage devices 20 optionally accessed by one or more optional controllers 18;
a user interface 4, the user interface 4 including a display 6 and a keyboard or keypad 8;
one or more communication busses 12 for interconnecting the aforementioned components; and
a power supply 24 for powering the aforementioned components, which power supply can be, for example, batteries.
   In some embodiments, data in memory 14 can be seamlessly shared with optional non-volatile memory 20 using known computing techniques such as caching. In some embodiments the remote device 180 does not have a magnetic disk storage device. For instance, in some embodiments, the remote device 180 is a portable handheld computing device and the network interface 10 communicates with the Internet/network 126 by wired or wireless means.

The memory 14 preferably stores:
an operating system 130 that includes procedures for handling various basic system services and for performing hardware dependent tasks;
operating system 130 includes a gatekeeper warehouse controller (application installation module) 132 that is responsible for installing applications on the remote device 180, gatekeeper warehouse controller 132 forms a catalog of the resources requested by an application in the process of installing the application on the remote device 180;
a permissions application 134 which has electronic access to an information store 36 that comprises a plurality of permissions, each permission in the plurality of permissions associated with a corresponding resource in a plurality of resources associated with the remote device 180, where the information store specifies, for each respective resource in the plurality of resources, which applications 140 in a plurality of applications installed on the remote device 180 have run-time access permission to use the respective resource;
a network communications module 138 that is used for connecting the remote device 180 to the central device 100 (FIG. 1) via one or more communication networks, such as the Internet, other wide area networks, local area networks (e.g., a local wireless network can connect the remote device 180 to the central device 100), metropolitan area networks, and so on; and
a plurality of applications 140, each application containing a permissions declaration 142.

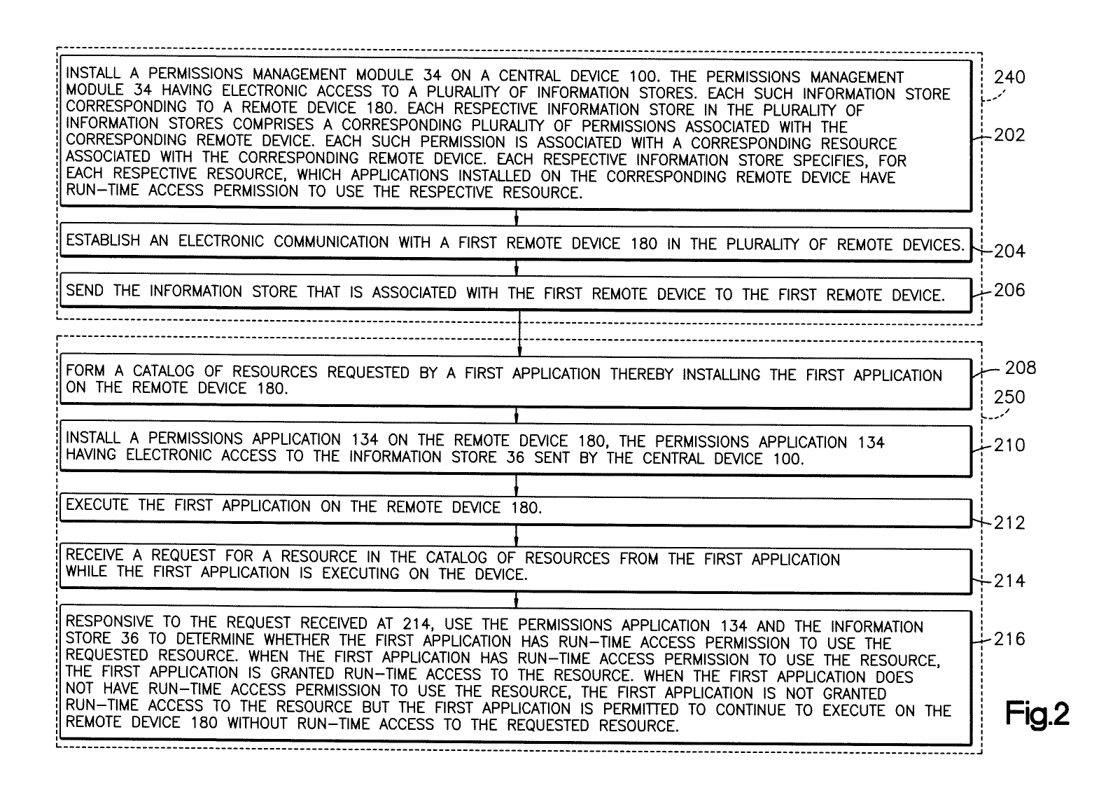

Now that an exemplary topology in accordance with an embodiment of the systems of the present disclosure has been described, an exemplary method in accordance with a first embodiment of the present disclosure will be described in conjunction with FIG. 2. It will be appreciated that in many instances, unless otherwise noted below, the steps presented below do not have to be performed in the order presented below. Furthermore, such alternative temporal orderings of the steps are within the scope of the present disclosure. As indicated by boxes 240 and 250 in FIG. 2, steps 202 through 206 and steps 208 through 216 form two distinct groups. This is because in the embodiment illustrated in FIG. 2, steps 202 through 206 are performed by central device 100 whereas steps 208 through 216 are performed by a remote device 180.

Step 202. In step 201, a permissions management module 34 is installed on a central device 100. The permissions management module 34 has electronic access to a plurality of information stores 38. Typically, this means that the information stores 38 are actually stored on central device 100, be it in memory 120, 114, or some combination of the two. However, it will be appreciated that that there is no requirement that the information stores 38 actually be stored on central device 100 provided that permissions management module 34 has electronic access to such information stores 36.

In typical embodiments, each such information store 36 corresponds to a remote device 180. In some instances, this means that each remote device 180 has a unique and corresponding information store 36 that does not relate to any other remote device 180. In such instances, the number of information stores 36 equals the number of remote devices 180.

In some instances, the number of information stores 36 is less than the number of remote devices 180. In such instances, the remote devices 180 are categorized by class and, for each such class, there is an information store 36 corresponding to the class. For example, consider the case where there are five remote devices 180 and two classes, termed class A and class B. In this case, the five remote devices 180 are categorized into either class A or class B. Then, a first information store 36 is applicable to all remote devices 180 in class A and a second information store 36 is applicable to all remote devices in class B.

In still other instances, the number of information stores 36 exceeds the number of remote devices 180. In such instances, each remote device 180 may be associated with more than one information store 36. Such a situation may arise, for example, when an information technology administrator has developed many different versions of an information store 36 that is applicable to a particular remote device 180. Such versions may be improvements over each other, or various of such versions may be more apt on some occasions than others. For instance, the information technology administrator may develop an information store 36 for a particular remote device 180 when the administrator the person assigned to the device is on maternity leave and another information store 36 for the device when that person returns from maternity leave.

It will be appreciated that the term “information store” is for labeling purposes only. In fact, an information store 36 may exist as any form of data storage including, but not limited to, a flat file, database (e.g., a relational SQL database, an on-line analytical processing database), or other form of data structure. Moreover, in some embodiments, all the information stores 36 exist in the same flat file, database or other form of data structure while in other embodiments they do not. In some embodiments, the information stores 36 are stored in a single database. In other embodiments, this data is stored in a plurality of databases that may or may not all be hosted by the same computer 100. In such embodiments, some components of the data structures 36 are stored on computer systems that are not illustrated by FIG. 1 but that are addressable by central device 100 over network 126.

Each respective information store 36 in the plurality of information stores comprises a corresponding plurality of permissions associated with the remote device corresponding to the respective information store. For instance, information store 36 “X” which corresponds to a remote device 180 “X” will contain a plurality of permissions for remote device 180 “X”. Each such respective permission pertains to a corresponding resource associated with the device. For instance, in the case of information store 36 “X” which corresponds to a remote device 180 “X”, there may be a first permission and a second permission. The first permission pertains to a first resource associated with the remote device “X” and the second permission pertains to a second resource associated with the remote device “X”.

Moreover, each respective information store 38 specifies, for each respective resource, which applications installed on the remote device corresponding to the respective information store have run-time access permission to use the respective resource. So, in the example where information store 36 “X”, which corresponds to a remote device 180 “X”, where there is a first permission that pertains to a first resource associated with the remote device “X” and there is a second permission that pertains to a second resource associated with the remote device “X”, the information store 36 will specify, e.g., through the permission setting, which applications can use the first resource and which applications can use the second resource.

In some embodiments, applications that do not have approval for a specific permission (e.g., such applications are to be denied the resource associated with the specific permission) are simply not specified. For instance, if a permission in an information store 36 determines which applications have access to a contact list application, any application not specified in the information store 36 as being approved to access the contact list application is not granted access to the contact list.

In one embodiment, the permissions that are granted to specific applications are specified as one or more rule 38. For example, the set of rules associated with a contact list application that runs on the remote device 180 associated with a given information store 36 may have the form set forth in the following table.

| Rule | | | |
|---|---|---|---|
| Number | Resource | Application List | Permission |
| 1 | contact list | App₁, . . . , Appₙ | Allow access to the |
| | application | | contact list application |
| 2 | contact list | Any application other | Disallow access to the |
| | application | than App₁, . . . , Appₙ | contact list application |

Thus, rule 1 specifies which applications are allowed to access the contact list application on the particular remote device 180 and rule 2 specifies that any application not in rule 1 is not allowed to access the contact list application on that remote device 180. The combination of rules 1 and 2 specifies that, for all applications that may run on remote device 180, do not grant access to the contact list application unless the application is in the set of applications App₁, . . . , Appₙ. There is any number of logical ways in which the information store 38 may specify a given permission for a resource and the application list that has the given permission and the example provided here is meant simply to illustrate one such way.

Nonlimiting examples of resources that can each be gated by a permission specified in an information store 36 include the resources specified in version 2.3 of the Android operating system (GOOGLE, Mountain View, Calif.). These resources are summarized in the table in Section 6.1 below. Nonlimiting examples of resources and their associated permissions that can be found in an information store 36 for a remote device 180 are found in Section 6.2 below.

One type of resource that the systems and methods of the present disclosure can be used to control access to is applications. In the Android operating system, each application runs in its own sandbox such that other applications cannot directly access the files created by a particular application. What can be done, as in the case of the contact list application, is to grant access an application to the actual application which created the file of interest. Thus, in the systems and methods of the present disclosure, access to an application is one form of resource that can be controlled. So, any number of custom applications can be installed on a remote device 180 and the systems and methods of the present application can be used to specify detailed rules 38 on which applications can access such installed applications. In this way, a custom application that creates and stores sensitive company data can be written. In of itself, the custom application is secure because the files created by the custom application (the sensitive company data) are in their own sandbox. No other applications can directly access this information. But suppose that the custom application lacks certain functionality that is possessed by a different application (e.g., a secondary application). In such a case, it is desired to grant the secondary application access to the custom application. In this way, the secondary application can access the data created by the custom application through the custom application. Such custom applications can be defined as a resource with a corresponding permission which grants access to the custom application. Then, only those applications that an administrator deems necessary or prudent to the custom application are granted access. In this way, sensitive data of any nature can be protected. Further, it is not necessary to attempt to write a single custom application that handles all the functionality that is desired. Rather, sensitive data can be managed by a custom application and access can be granted to trusted secondary applications as needed.

Step 204. In step 204, electronic communication is established between central server 100 and a first remote device 180 in a plurality of remote devices. Such electronic communication can be through wired or wireless means using any of a number of known conventional techniques. In typical embodiments, a component step 204 is to locating a specific first remote device 180 based on a unique identifier associated with the device (e.g., a device serial number) and/or based on a unique identity of the user associated with the device and/or based on a class type of the first remote device 180. Identification of a specific first remote device 180 in this way ensures that the appropriate information store 36 will be sent to the first remote device 180. Note that it is not required in all embodiments of the present disclosure that such identification uniquely identify a first remote device 180. For example, in instances where a corporation has only two classes of devices, the corporation may have only two information store 36, one for each class type. In such instances, it may be only necessary to identify the class of a first remote device in step 204 in order to ensure that the device receives the correct information store 36.

Step 206. In step 206, with the appropriate electronic communication established in step 204, the information store 36 that is associated with the first remote device 180 is sent to the first remote device. In some embodiments, this involves sending or otherwise making available the rules 38 of the information store 36 associated with the first remote device 180 to the first remote device where they are then electronically stored. However, this is not required in all embodiments. For instance, the central device 100 could simply send the remote device a pointer or URL where the rules 38 reside. In another example, the remote device could simply query the rules 38 on the central server on an as needed basis. Such an embodiment would facilitate the continual update of the rules on the central server which are then enforced by the remote devices. Moreover, as has been indicated above, information stores 36 that are not comprised of rules 38 are within the scope of the present disclosure. So, in such embodiments, any mechanism by which the white list of applications, for each resource germane to the information store 36 for the first remote device 180, and their associated permissions is sent to or made addressable by the remote device 180 is within the present disclosure.

As a consequence of steps 204 and 206, is that the remote device 180 now has electronic access to the information store 36 from the central device 100 that is associated with the remote device 180. So, in the instance where such an information store 36 is a set of rules 38, as a consequence of steps 204 and 206, the remote device 180 now has electronic access to the set of rules 38 associated with the remote device.

Step 208. In step 208 a catalog of the resources requested by a first application 140 is made thereby installing the first application on the remote device 180. In fact, step 208 is inherently performed on remote devices 180 that run under the Android operating system. Before an Android application is installed, or created for that matter, the application developer specifies a set of permissions that the application needs at run-time to actually run. This is specified in the AndroidManifest.xml file that appears in the root directory of the Android application. In some embodiments, the gatekeeper warehouse controller 132 is responsible for cataloging the resources that an application 140 requires as part of the installation process that takes place in step 208.

Step 208 includes operating level system support for approving the catalog of resources requested by the first application. This allows the application to be installed. Not restriction is placed by the systems and methods of the present disclosure on the type of resources that the first application may request. This allows for the flexible installation of any application that the user may desire on the remote device 180. The user may, of course, decide without using the permissions application 134, to deny a particular application certain resources or bar an application from installing altogether. However, the intent of the systems and methods of the present application is to facilitate easier installation of applications onto a remote device 180. Therefore, advantageously, careful review of the resources that the first application requires and that are cataloged by the operating system is not needed.

Step 210. In step 210, a permissions application 134 is installed on the remote device 180. The permissions application 134 has electronic access to the information store 36 sent by the central device 100. It will be clearly appreciated that the permissions application 134 may be installed before or after the first application 140 is installed in step 208. All that is needed is that the permissions application 134 be installed before the first application 140 is executed. The permissions application 134, in conjunction with the information store 36, monitor an application 140 when it is executed on the remote device 180.

Step 212. In step 212, a first application 140 is executed on the remote device 180. The first application 140 is monitored for resource requests by permissions application 134. However, until the first application 140 requests such a resource, no action is taken by the permissions application 134. When the first application 140 does make a request for a resource process control proceeds to step 214.

Step 214. As noted above, step 214 is triggered when the first application 140 running on the remote device 180 makes a request for a resource. This request is received by permissions application 134 for a resource in the catalog of resources from the first application 140 while the application 140 is executing on the device. This request is processed by the permission application 134 even though the gate warehouse controller 132 granted the application 140 the right to use the requested resource as part of the application 140 installation process.

Step 216. Responsive to the request received at 214, the permissions application 134 and the information store 36 are used to determine whether the first application 140 has run-time access permission to use the requested resource. When the first application has run-time access permission to use the resource, the first application is granted run-time access to the resource. When the first application does not have run-time access permission to use the resource, the first application is not granted run-time access to the resource but the first application is permitted to continue to execute on the remote device 180 without run-time access to the requested resource.

Now that examples of systems and methods in accordance with the present disclosure have been presented with reference to FIGS. 1 and 2, some of the advantages of the present disclosure can be reviewed. Advantageously, the systems and methods of the present disclosure allow an information technology administrator to enforce an application specific permission policy at the enterprise level at application run-time. This is done by installing a permissions application 134 on each remote device 180 under the responsibility of the information technology administrator. The permissions application 134 acts when an application 140 is executed. Upon execution of a given application 140 on the remote device 180 and the request for a resource by the executed application 140, the permissions application 134 checks to see whether given application is permitted to use the resource against a “white list” and only allows the given application to use the resource if it is on the white list for that resource. This is the case even when the given application 140 had declared that it needed the resource when the application 140 was being installed and even in the case where the user, upon installation of the application 104, had actually granted the application 140 permission to use the resource. In this way, the question asked for each remote device 180 is no longer which applications 140 can be installed on the device 140 and which cannot but rather, for each respective application 140 installed, what permissions is the application 140 granted at run-time. In this way, corporate data is secured even in instances where users are allowed to run personal applications 140 on their device 180.

The Android operating system defines several different resources, with each such respective resource having an associated permission to access the respective resource or not. The systems and methods of the present disclosure allow for the control, at a resource specific level, which applications 140 may use each such resource and which may not. Exemplary resources that are defined in the Android operating system and therefore can be controlled include, but are not limited to, a contacts list, Wi-Fi connection, blue tooth access, screen access, and access to storage to name a few. More such resources are detailed in Section 6.1 below. Moreover, the Android operating system permits users to define resources and define the permissions to access such resources. For example, a sensitive company document, such as blueprints, business plans, or a catalog, can be defined as a custom resource and a unique permission to access this resource created. The permission can be, for example, “give permission to this defined resource to anyone that has the same signature as me”. The net effect of such a permission grant is that permission would be essentially only granted to the creator of the custom resource. Other examples include “do not grant permission to this custom resource to anyone” or “grant permission to this custom resource to everyone”. Then, using the systems and methods of the present disclosure, access to such custom resources is advantageously regulated on an application by application basis when such applications are executed in accordance with the custom permissions associated with each such custom resource. Custom permissions that are not part of the Android operating system are declared using the <permission> tag. Each permission must be defined in the Android manifest file and can be applied to specific resources—notably an activity or a service—within an application.

The systems and methods of present disclosure are particularly advantageous because they remove the burden of screening the ever growing library of applications 140 that can run on remote devices 180 to determine which applications 140 are “safe” to run on such devices. Rather than screening batches of applications 140 as they are released into the public domain on a daily basis, an IT administrator can instead focus on protecting device resources, whether such resources are custom resources defined by the IT administrator, resources defined by the operating system 130, or some combination of the two. In some embodiments, an end user is permitted to download any application 140 desired and any such application 140 is permitted to run and access any resources to which it has run-time permission to use. Thus, the systems and methods of the present disclosure allow an IT administrator or a manager of one or more devices 180 to define (i) what is to be protected and (ii) who (which people, which applications) has accessed to such protected resources.

Without the systems and methods of the present disclosure, an IT administrator would be faced with either (i) the intractable problem of screening every possible application 140 that can be run on remote devices 180 to make sure they are “safe” or (ii) barring users from downloading and installing applications 140 on such devices 180. Neither option is tenable, and the systems and methods of the present disclosure alleviate the need to pursue such untenable options.

A specific example of how the systems and methods of the present disclosure may be used arises in the case where there is a salesman that has a remote device 180. The salesman wishes to use a particular application 140 which is known to require access to the contacts list application on the remote device 180. The IT manager considers the salesman's request to install the application 140 on the remote device 180. The IT manager is familiar with the requested application 140, knows that the application 140 requires access to the contacts list application, and knows that the salesman needs the application 140 to do his job. So, the IT manager pushes a policy (white list), also termed an information store 36 to the salesman's remote device 180 to be enforced by the permissions application 134 installed on the device 180. The policy 36 is unique to this salesman and it grants the application 140 permission to access the contacts list application. That is, at runtime, the permissions application 134 does not bar the application 140 request's for access to the contacts list application when the application 140 is run. Further suppose that a malicious application 140 is also installed on the same remote device 180. Such an installation could be the result of accessing some website on the Internet or because the malicious application was masked as a useful application that was of interest to the salesman. Regardless of why installed, when the malicious application 140 is executed and tries to access the contact list application, the permissions application 134 does not allow the malicious application to access the contact list application even though the permissions application 134 does allow the authorized application 140 running on the same remote device 180 access to the contact list application. The malicious application is allowed to continue to run even though it was denied access to the contact list application, provided that the malicious application was written in such a manner that it does not terminate when it is denied the requested resource.

### 6. SPECIFIC EXAMPLES

The present section details specific examples of certain components of the system and methods of the present disclosure.

### 6.1 Exemplary Resources Available in Version 2.3 of the Android Operating System

Nonlimiting examples of resources that can each be gated by a permission specified in an information store 36 include the resources specified in version 2.3 of the Android operating system (GOOGLE, Mountain View, Calif.) and are summarized in the following table.

| RESOURCE | RESOURCE DESCRIPTION |
|---|---|
| ACCESS_CHECKIN_PROPERTIES | Allows read/write access to the |
| | “properties” table in the checkin |
| | database, to change values that |
| | get uploaded. |
| ACCESS_COARSE_LOCATION | Allows an application to access |
| | coarse (e.g., Cell-ID, WiFi) |
| | location |
| ACCESS_FINE_LOCATION | Allows an application to access |
| | fine (e.g., GPS) location |
| ACCESS_LOCATION_EXTRA_COMMANDS | Allows an application to access |
| | extra location provider |
| | commands |
| ACCESS_MOCK_LOCATION | Allows an application to create |
| | mock location providers for |
| | testing |
| ACCESS_NETWORK_STATE | Allows applications to access |
| | information about networks |
| ACCESS_SURFACE_FLINGER | Allows an application to use |
| | SurfaceFlinger's low level |
| | features |
| ACCESS_WIFI_STATE | Allows applications to access |
| | information about Wi-Fi |
| | networks |
| ACCOUNT_MANAGER | Allows applications to call into |
| | AccountAuthenticators. |
| AUTHENTICATE_ACCOUNTS | Allows an application to act as an |
| | AccountAuthenticator for the |
| | AccountManager |
| BATTERY_STATS | Allows an application to collect |
| | battery statistics |
| BIND_APPWIDGET | Allows an application to tell the |
| | AppWidget service which |
| | application can access |
| | AppWidget's data. |
| BIND_DEVICE_ADMIN | Must be required by device |
| | administration receiver, to ensure |
| | that only the system can interact |
| | with it. |
| BIND_INPUT_METHOD | Must be required by an |
| | InputMethodService, to ensure |
| | that only the system can bind to |
| | it. |
| BIND_WALLPAPER | Must be required by a |
| | WallpaperService, to ensure that |
| | only the system can bind to it. |
| BLUETOOTH | Allows applications to connect to |
| | paired bluetooth devices. |
| BLUETOOTH_ADMIN | Allows applications to discover |
| | and pair bluetooth devices. |
| BRICK | Required to be able to disable the |
| | device. |
| BROADCAST_PACKAGE_REMOVED | Allows an application to |
| | broadcast a notification that an |
| | application package has been |
| | removed. |
| BROADCAST_SMS | Allows an application to |
| | broadcast an SMS receipt |
| | notification. |
| BROADCAST_STICKY | Allows an application to |
| | broadcast sticky intents. |
| BROADCAST_WAP_PUSH | Allows an application to |
| | broadcast a WAP PUSH receipt |
| | notification. |
| CALL_PHONE | Allows an application to initiate |
| | a phone call without going |
| | through the Dialer user interface |
| | for the user to confirm the call |
| | being placed. |
| CALL_PRIVILEGED | Allows an application to call any |
| | phone number, including |
| | emergency numbers, without |
| | going through the Dialer user |
| | interface for the user to confirm |
| | the call being placed. |
| CAMERA | Required to be able to access the |
| | camera device. |
| CHANGE_COMPONENT_ENABLED_STATE | Allows an application to change |
| | whether an application |
| | component (other than its own) is |
| | enabled or not. |
| CHANGE_CONFIGURATION | Allows an application to modify |
| | the current configuration, such as |
| | locale. |
| CHANGE_NETWORK_STATE | Allows applications to change |
| | network connectivity state. |
| CHANGE_WIFI_MULTICAST_STATE | Allows applications to enter Wi- |
| | Fi Multicast mode. |
| CHANGE_WIFI_STATE | Allows applications to change |
| | Wi-Fi connectivity state. |
| CLEAR_APP_CACHE | Allows an application to clear the |
| | caches of all installed |
| | applications on the device. |
| CLEAR_APP_USER_DATA | Allows an application to clear |
| | user data. |
| CONTROL_LOCATION_UPDATES | Allows enabling/disabling |
| | location update notifications |
| | from the radio. |
| DELETE_CACHE_FILES | Allows an application to delete |
| | cache files. |
| DELETE_PACKAGES | Allows an application to delete |
| | packages. |
| DEVICE_POWER | Allows low-level access to power |
| | management |
| DIAGNOSTIC | Allows applications to RW to |
| | diagnostic resources. |
| DISABLE_KEYGUARD | Allows applications to disable |
| | the keyguard |
| DUMP | Allows an application to retrieve |
| | state dump information from |
| | system services. |
| EXPAND_STATUS_BAR | Allows an application to expand |
| | or collapse the status bar. |
| FACTORY_TEST | Run as a manufacturer test |
| | application, running as the root |
| | user. |
| FLASHLIGHT | Allows access to the flashlight. |
| FORCE_BACK | Allows an application to force a |
| | BACK operation on whatever is |
| | the top activity. |
| GET_ACCOUNTS | Allows access to the list of |
| | accounts in the Accounts Service |
| GET_PACKAGE_SIZE | Allows an application to find out |
| | the space used by any package. |
| GET_TASKS | Allows an application to get |
| | information about the currently |
| | or recently running tasks: a |
| | thumbnail representation of the |
| | tasks, what activities are running |
| | in it, etc. |
| GLOBAL_SEARCH | This permission can be used on |
| | content providers to allow the |
| | global search system to access |
| | their data. |
| HARDWARE_TEST | Allows access to hardware |
| | peripherals. |
| INJECT_EVENTS | Allows an application to inject |
| | user events (keys, touch, |
| | trackball) into the event stream |
| | and deliver them to ANY |
| | window. |
| INSTALL_LOCATION_PROVIDER | Allows an application to install a |
| | location provider into the |
| | Location Manager |
| INSTALL_PACKAGES | Allows an application to install |
| | packages. |
| INTERNAL_SYSTEM_WINDOW | Allows an application to open |
| | windows that are for use by parts |
| | of the system user interface. |
| INTERNET | Allows applications to open |
| | network sockets. |
| KILL_BACKGROUND_PROCESSES | Allows an application to call |
| | killBackgroundProcesses(String). |
| MANAGE_ACCOUNTS | Allows an application to manage |
| | the list of accounts in the |
| | AccountManager. |
| MANAGE_APP_TOKENS | Allows an application to manage |
| | (create, destroy, Z-order) |
| | application tokens in the window |
| | manager. |
| MODIFY_AUDIO_SETTINGS | Allows an application to modify |
| | global audio settings. |
| MODIFY_PHONE_STATE | Allows modification of the |
| | telephony state - power on, mmi, |
| | etc. |
| MOUNT_FORMAT_FILESYSTEMS | Allows formatting file systems |
| | for removable storage. |
| MOUNT_UNMOUNT_FILESYSTEMS | Allows mounting and |
| | unmounting file systems for |
| | removable storage. |
| NFC | Allows applications to directly |
| | communicate over NFC |
| PERSISTENT_ACTIVITY | This constant is deprecated. This |
| | functionality will be removed in |
| | the future; please do not use. |
| | Allow an application to make its |
| | activities persistent. |
| PROCESS_OUTGOING_CALLS | Allows an application to monitor, |
| | modify, or abort outgoing calls. |
| READ_CALENDAR | Allows an application to read the |
| | user's calendar data. |
| READ_CONTACTS | Allows an application to read the |
| | user's contacts data. |
| READ_FRAME_BUFFER | Allows an application to take |
| | screen shots and more generally |
| | get access to the frame buffer |
| | data. |
| READ_HISTORY_BOOKMARKS | Allows an application to read |
| | (but not write) the user's |
| | browsing history and bookmarks. |
| READ_INPUT_STATE | Allows an application to retrieve |
| | the current state of keys and |
| | switches. |
| READ_LOGS | Allows an application to read the |
| | low-level system log files. |
| READ_PHONE_STATE | Allows read only access to phone |
| | state. |
| READ_SMS | Allows an application to read |
| | SMS messages. |
| READ_SYNC_SETTINGS | Allows applications to read the |
| | sync settings |
| READ_SYNC_STATS | Allows applications to read the |
| | sync stats. |
| REBOOT | Required to be able to reboot the |
| | device. |
| RECEIVE_BOOT_COMPLETED | Allows an application to receive |
| | the |
| | ACTION_BOOT_COMPLETED |
| | that is broadcast after the system |
| | finishes booting. |
| RECEIVE_MMS | Allows an application to monitor |
| | incoming MMS messages, to |
| | record or perform processing on |
| | them. |
| RECEIVE_SMS | Allows an application to monitor |
| | incoming SMS messages, to |
| | record or perform processing on |
| | them. |
| RECEIVE_WAP_PUSH | Allows an application to monitor |
| | incoming WAP push messages. |
| RECORD_AUDIO | Allows an application to record |
| | audio. |
| REORDER_TASKS | Allows an application to change |
| | the Z-order of tasks |
| RESTART_PACKAGES | This constant is deprecated. |
| SEND_SMS | Allows an application to send |
| | SMS messages. |
| SET_ACTIVITY_WATCHER | Allows an application to watch |
| | and control how activities are |
| | started globally in the system. |
| SET_ALARM | Allows an application to |
| | broadcast an Intent to set an |
| | alarm for the user. |
| SET_ALWAYS_FINISH | Allows an application to control |
| | whether activities are |
| | immediately finished when put in |
| | the background. |
| SET_ANIMATION_SCALE | Modify the global animation |
| | scaling factor. |
| SET_DEBUG_APP | Configure an application for |
| | debugging. |
| SET_ORIENTATION | Allows low-level access to |
| | setting the orientation (actually |
| | rotation) of the screen. |
| SET_PROCESS_LIMIT | Allows an application to set the |
| | maximum number of (not |
| | needed) application processes |
| | that can be running |
| SET_TIME | Allows applications to set the |
| | system time. |
| SET_TIME_ZONE | Allows applications to set the |
| | system time zone. |
| SET_WALLPAPER | Allows applications to set the |
| | wallpaper. |
| SET_WALLPAPER_HINTS | Allows applications to set the |
| | wallpaper hints. |
| SIGNAL_PERSISTENT_PROCESSES | Allow an application to request |
| | that a signal be sent to all |
| | persistent processes. |
| STATUS_BAR | Allows an application to open, |
| | close, or disable the status bar |
| | and its icons. |
| SUBSCRIBED_FEEDS_READ | Allows an application to allow |
| | access the subscribed feeds |
| | ContentProvider. |
| SYSTEM_ALERT_WINDOW | Allows an application to open |
| | windows using the type |
| | TYPE_SYSTEM_ALERT, |
| | shown on top of all other |
| | applications. |
| UPDATE_DEVICE_STATS | Allows an application to update |
| | device statistics. |
| USE_CREDENTIALS | Allows an application to request |
| | authtokens from the |
| | AccountManager. |
| USE_SIP | Allows an application to use SIP |
| | service |
| VIBRATE | Allows access to the vibrator. |
| WAKE_LOCK | Allows using PowerManager |
| | WakeLocks to keep processor |
| | from sleeping or screen from |
| | dimming. |
| WRITE_APN_SETTINGS | Allows applications to write the |
| | apn settings. |
| WRITE_CALENDAR | Allows an application to write |
| | (but not read) the user's calendar |
| | data. |
| WRITE_CONTACTS | Allows an application to write |
| | (but not read) the user's contacts |
| | data. |
| WRITE_EXTERNAL_STORAGE | Allows an application to write to |
| | external storage |
| WRITE_GSERVICES | Allows an application to modify |
| | the Google service map. |
| WRITE_HISTORY_BOOKMARKS | Allows an application to write |
| | (but not read) the user's browsing |
| | history and bookmarks. |
| WRITE_SECURE_SETTINGS | Allows an application to read or |
| | write the secure system settings. |
| WRITE_SETTINGS | Allows an application to read or |
| | write the system settings. |
| WRITE_SMS | Allows an application to write |
| | SMS messages. |
| WRITE_SYNC_SETTINGS | Allows applications to write the |
| | sync settings |

### 6.2 Nonlimiting Examples of Resources and their Associated Permissions

With reference to FIG. 1, the present section provide nonlimiting examples of resources and their associated permissions that can be found in an information store 36 for a remote device 180.

In some embodiments the device resource is access to information about a network associated with a remote device 180 and the run-time access permission associated with the remote device 180 resource described in information store 36 is allowing or disallowing one or more application installed on the remote device 180 to access the information about the network.

In some embodiments the device resource is access to information about a Wi-Fi network that is electronically accessible by a remote device 180 and the run-time access permission is associated with the remote device resource described in information store 36 is allowing or disallowing one or more specified applications installed on the remote device 180 to access the information about the Wi-Fi network.

In some embodiments the device resource is a battery statistic for a battery powering a remote device 180 and the run-time access permission associated with the device resource described in information store 36 is allowing or disallowing one or more applications installed on the remote device 180 to collect the battery statistic.

In some embodiments the device resource is a connecting to a bluetooth device paired with a remote device 180 and the run-time access permission associated with the device resource described in information store 36 is allowing or disallowing one or more applications installed on the remote device 180 to perform the connecting.

In some embodiments the device resource is discovering and pairing a bluetooth device with a remote device 180 and the run-time access permission associated with the device resource described in information store 36 is allowing or disallowing one or more applications installed on the remote device 180 to perform the discovering and pairing.

In some embodiments the device resource is a broadcast by a remote device 180 of an SMS receipt notification and the run-time access permission associated with the device resource described in information store 36 is allowing or disallowing one or more applications installed on the remote device 180 to perform the broadcast.

In some embodiments the device resource is a camera associated with a remote device 180 and the run-time access permission associated with the device resource described in information store 36 is allowing or disallowing one or more applications installed on the remote device 180 access the camera.

In some embodiments the device resource is a modification of a current configuration of a remote device 180 and the run-time access permission associated with the device resource described in information store 36 is allowing or disallowing one or more remote applications installed on the remote device 180 to make the modification.

In some embodiments the device resource is a change in a network connectivity state for a remote device 180 and the run-time access permission associated with the device resource described in information store 36 is allowing or disallowing one or more application installed on the remote device 180 to make the change.

In some embodiments the device resource is entering a Wi-Fi Multicast mode and the run-time access permission associated with the device resource described in information store 36 is allowing or disallowing one or more applications installed on the remote device 180 to enter the Wi-Fi Multicast mode.

In some embodiments the device resource is a change of a Wi-Fi connectivity state of a remote device 180 and the run-time access permission associated with the device resource described in information store 36 is allowing or disallowing one or more applications installed on the remote device 180 to make the change in the Wi-Fi connectivity state.

In some embodiments the device resource is a cache of an application installed on a remote device 180 and the run-time access permission associated with the device resource described in information store 36 is allowing or disallowing one or more applications installed on the remote device 180 to clear the cache.

In some embodiments the device resource is user data on a remote device 180 and the run-time access permission associated with the device resource described in information store 36 is allowing or disallowing one or more applications installed on the remote device 180 to clear the user data.

In some embodiments the device resource is one or more location update notifications from the radio associated with a remote device 180 and the run-time access permission associated with the device resource described in information store 36 is allowing or disallowing one or more applications installed on the remote device 180 to enable/disable the one or more location update notifications from the radio.

In some embodiments the device resource is a cache file stored by a remote device 180 and the run-time access permission associated with the device resource described in information store 36 is allowing or disallowing one or more applications installed on the remote device 180 to delete the cache file.

In some embodiments the device resource is a package installed on a remote device 180 and the run-time access permission associated with the device resource described in information store 36 is allowing or disallowing one or more applications installed on the remote device 180 to delete the package.

In some embodiments the device resource is a device power management associated with a remote device 180 and the run-time access permission associated with the device resource described in information store 36 is allowing or disallowing one or more applications installed on the remote device 180 low-level access to the device power management.

In some embodiments the device resource is a keyguard associated with a remote device 180 and the run-time access permission associated with the device resource described in information store 36 is allowing or disallowing one or more remote applications installed on the remote device 180 to disable the keyguard.

In some embodiments the device resource is a status bar displayed by a remote device and the run-time access permission associated with the device resource described in information store 36 is allowing or disallowing one or more applications installed on the remote device to expand or collapse the status bar on a display associated with the remote device 180.

In some embodiments the device resource is a flashlight associated with a remote device 180 and the run-time access permission associated with the device resource described in information store 36 is allowing or disallowing one or more applications installed on the remote device 180 to turn the flashlight on or off.

In some embodiments the device resource is determining the space used by a package installed on a remote device 180 and the run-time access permission associated with the device resource described in information store 36 is allowing or disallowing one or more applications installed on the remote device 180 to find out the space used by the package.

In some embodiments the device resource is information about a currently or recently running task including a thumbnail representation of the task and an activity the task is running on the remote device 180 and the run-time access permission associated with the device resource described in information store 36 is allowing or disallowing one or more applications installed on the remote device 180 to get the information about the currently or recently running task.

In some embodiments the device resource is a package and the run-time access permission associated with the device resource described in information store 36 is allowing or disallowing one or more applications installed on a remote device 180 to install the package on the remote device 180.

In some embodiments the device resource is an opening or closing of a network socket using a remote device 180 and the run-time access permission associated with the device resource described in information store 36 is allowing or disallowing one or more applications installed on the remote device 180 to open or close the network socket.

In some embodiments the device resource is a global audio setting associated with a remote device 180 and the run-time access permission associated with the device resource described in information store 36 is allowing or disallowing one or more applications installed on the remote device 180 to modify the global audio setting.

In some embodiments the device resource is a formatting of a file system for removable storage associated with a remote device 180 and the run-time access permission associated with the device resource described in information store 36 is allowing or disallowing one or more applications installed on the remote device 180 to perform the formatting.

In some embodiments the device resource is a mounting or an unmounting of a file system for a removable storage system associated with a remote device 180, and the run-time access permission associated with the device resource described in information store 36 is allowing or disallowing one or more applications installed on the remote device 180 to perform the mounting or the unmounting.

In some embodiments the device resource is a monitoring, a modification, or an aborting of an outgoing call from a remote device 180 and the run-time access permission associated with the device resource described in information store 36 is allowing or disallowing one or more applications installed on the remote device 180 to perform the monitoring, modification, or aborting of the outgoing call.

In some embodiments the device resource is a user's calendar data on a remote device 180 and the run-time access permission associated with the device resource described in information store 36 is granting one or more applications installed on the remote device 180 read access to the user's calendar data.

In some embodiments the device resource is a user's contacts data stored on a remote device 180 and the run-time access permission associated with the device resource described in information store 36 is allowing or disallowing one or more applications installed on the remote device 180 read access to the user's contacts data.

In some embodiments the device resource is an SMS message received by a remote device 180 and the run-time access permission associated with the device resource described in information store 36 is allowing or disallowing one or more applications installed on the remote device 180 read access to the SMS message.

In some embodiments the device resource is a reboot of a remote device 180 and the run-time access permission associated with the device resource described in information store 36 is allowing or disallowing one or more applications installed on the remote device 180 to reboot the device.

In some embodiments the device resource is a monitoring of an SMS message received by a remote device 180 and a recordal or processing on the SMS message and the run-time access permission associated with the device resource described in information store 36 is allowing or disallowing one or more applications installed on the remote device 180 to monitor the SMS message and to record or perform processing on the SMS message.

In some embodiments the device resource is recording audio on a remote device 180 and the run-time access permission associated with the device resource described in information store 36 is allowing or disallowing one or more applications installed on the remote device 180 to record audio on the remote device 180.

In some embodiments the device resource is a sending of an SMS message using a remote device 180 and the run-time access permission associated with the device resource described in information store 36 is allowing or disallowing one or more applications installed on the remote device 180 to perform the sending of the SMS message.

In some embodiments the device resource is a remote device 180 system time and the run-time access permission associated with the device resource described in information store 36 is allowing or disallowing one or more applications installed on the remote device 180 to set the remote device 180 system time.

In some embodiments the device resource is a remote device 180 system time zone and the run-time access permission associated with the device resource described in information store 36 is allowing or disallowing one or more applications installed on the remote device 180 to set the remote device 180 system time zone.

In some embodiments the device resource is a device wallpaper displayed by a remote device 180 and the run-time access permission associated with the device resource described in information store 36 is allowing or disallowing one or more applications installed on the remote device 180 to set the device wallpaper.

In some embodiments the device resource is a vibrator associated with a remote device 180 and the run-time access permission associated with the device resource described in information store 36 is allowing or disallowing one or more application installed on the remote device 180 to access or activate the vibrator.

In some embodiments the device resource is a user's calendar data on a remote device 180 and the run-time access permission associated with the device resource described in information store 36 is allowing or disallowing one or more applications to write to the user's calendar data.

In some embodiments the device resource is a user's contacts data on a remote device 180 and the run-time access permission associated with the device resource described in information store 36 is allowing or disallowing one or more applications installed on the remote device 180 to write to the user's contacts data.

In some embodiments the device resource is writing to a storage that is external to a remote device 180 and the run-time access permission associated with the device resource described in information store 36 is allowing or disallowing one or more applications installed on the remote device 180 to write to the external storage.

In some embodiments the device resource is a user's browsing history or bookmarks on a remote device 180 and the run-time access permission associated with the device resource described in information store 36 is allowing or disallowing the one or more applications installed on the remote device 180 to write to the user's browsing history or bookmarks.

In some embodiments the device resource is an SMS message and the run-time access permission associated with the device resource described in information store 36 is allowing or disallowing one or more applications installed on the remote device 180 to write the SMS message.

### 7. REFERENCES CITED AND ALTERNATIVE EMBODIMENTS

All references cited herein are incorporated herein by reference in their entirety and for all purposes to the same extent as if each individual publication or patent or patent application was specifically and individually indicated to be incorporated by reference in its entirety for all purposes.

The present invention can be implemented as a computer program product that comprises a computer program mechanism embedded in a computer readable storage medium. For instance, the computer program product could contain the program modules shown in FIG. 1. These program modules can be stored on a CD-ROM, DVD, magnetic disk storage product, or any other tangible computer readable data or program storage product.

Many modifications and variations of this invention can be made without departing from its spirit and scope, as will be apparent to those skilled in the art. The specific embodiments described herein are offered by way of example only. The embodiments were chosen and described in order to best explain the principles of the invention and its practical applications, to thereby enable others skilled in the art to best utilize the invention and various embodiments with various modifications as are suited to the particular use contemplated. The invention is to be limited only by the terms of the appended claims, along with the full scope of equivalents to which such claims are entitled.

What is claimed:

1. A device comprising:
one or more processing units;
a memory, coupled to at least one of the one or more processing units, the memory storing:
an operating system having an application installation module, wherein the application installation module comprises instructions for forming a catalog of the resources requested by a first application thereby installing the first application on the device;
a permissions application, the permissions application having electronic access to an information store that comprises a plurality of permissions, each permission in the plurality of permissions associated with a corresponding resource in a plurality of resources associated with the device, wherein the information store specifies, for each respective resource in the plurality of resources of the device, which applications in a plurality of applications have run-time access permission to use the respective resource, the plurality of applications including the first application;
the memory further comprising instructions that are executed by at least one of the one or more processing units, the instructions comprising instructions for:
(A) executing the first application on the device;
(B) receiving a request for a resource in the catalog of resources from the first application while the first application is executing on the device; and
(C) using, responsive to the request, the permissions application and the information store to determine whether the first application has a run-time access permission to use the resource, wherein,
when the first application has the run-time access permission to use the resource, the first application is granted run-time access to the resource; and
when the first application does not have the run-time access permission to use the resource, the first application is not granted run-time access to the resource and the first application is permitted to continue to execute on the device without run-time access to the requested resource.

2. The device of claim 1, wherein the information store comprises a plurality of rules, each rule in the plurality of rules corresponding to a permission in the plurality of permissions and a resource in the plurality of resources, and each respective rule in the plurality of rules specifying which applications in the plurality of installed applications has run-time access to the resource corresponding to the respective rule.

3. The device of claim 1 wherein the device is a hand-held device.

4. The device of claim 1 wherein the data store is stored in the memory.

5. The device of claim 1, wherein the memory further comprises instructions for electronically receiving the information store from a remote resource policy administrator.

6. The device of claim 1, wherein the memory further comprises instructions for electronically receiving the information store from a remote resource policy administrator over a wireless connection.

7. The device of claim 1, wherein the operating system is an Android operating system.

8. The device of claim 1, wherein
the resource is access to information about a network associated with the device and the run-time access permission is permitting the first application to access the information about the network,
the resource is access to information about a Wi-Fi network that is electronically accessible by the device and the run-time access permission is permitting the first application to access the information about the Wi-Fi network,
the resource is a battery statistic for a battery powering the device and the run-time access permission is permitting the first application to collect the battery statistic,
the resource is a connecting to a bluetooth device paired with the device and the run-time access permission is permitting the first application to perform the connecting,
the resource is discovering and pairing a bluetooth device with the device and the run-time access permission is permitting the first application to perform the discovering and pairing,
the resource is a broadcast by the device of an SMS receipt notification and the run-time access permission is permitting the first application to perform the broadcast,
the resource is a camera associated with the device and the run-time access permission is permitting the first application access the camera,
the resource is a modification of a current configuration of the device and the run-time access permission is permitting the first application to make the modification,
the resource is a change in a network connectivity state and the run-time access permission is permitting the first application to make the change,
the resource is entering a Wi-Fi Multicast mode and the run-time access permission is permitting the first application to enter the Wi-Fi Multicast mode,
the resource is a change of a Wi-Fi connectivity state of the device and the run-time access permission is permitting the first application to make the change in the Wi-Fi connectivity state,
the resource is a cache of an application installed on the device and the run-time access permission is permitting the first application to clear the cache,
the resource is user data on the device and the run-time access permission is permitting the first application to clear the user data,
the resource is one or more location update notifications from the radio associated with the device and the run-time access permission is permitting the first application to enable/disable the one or more location update notifications from the radio,
the resource is cache file stored by the device and the run-time access permission is permitting the first application to delete the cache file,
the resource is a package installed on the device and the run-time access permission is permitting the first application to delete the package,
the resource is a device power management associated with the device and the run-time access permission is permitting the first application low-level access to the device power management,
the resource is a keyguard associated with the device and the run-time access permission is permitting the first application to disable the keyguard,
the resource is a status bar displayed by the device and the run-time access permission is permitting the first application to expand or collapse the status bar on a display associated with the device,
the resource a flashlight associated with the device and the run-time access permission is permitting the first application to turn the flashlight on or off, the resource is determining the space used by a package installed on the device and the run-time access permission is permitting the first application to find out the space used by the package, or
the resource is information about a currently or recently running task including a thumbnail representation of the task and an activity the task is running, and the run-time access permission is permitting the first application to get the information about the currently or recently running task.

9. The device of claim 1, wherein
the resource is a package and the run-time access permission is permitting the first application to install the package on the device,
the resource is an opening or closing of a network socket using the device and the run-time access permission is permitting the first application to open or close the network socket,
the resource is a global audio setting associated with the device and the run-time access permission is permitting the first application to modify the global audio setting,
the resource is a formatting of a file system for removable storage associated with the device and the run-time access permission is permitting the first application to perform the formatting,
the resource is a mounting or an unmounting of a file system for a removable storage system associated with the device, and the run-time access permission is permitting the first application to perform the mounting or the unmounting,
the resource is a monitoring, a modification, or an aborting of an outgoing call from the device and the run-time access permission is permitting the first application to perform the monitoring, modification, or aborting of the outgoing call,
the resource is a user's calendar data on the device and the run-time access permission is granting the first application read access to the user's calendar data,
the resource is a user's contacts data and the run-time access permission is permitting the first application read access to the user's contacts data,
the resource is an SMS message received by the device and the run-time access permission is permitting the first application read access to the SMS message,
the resource is a reboot of the device and the run-time access permission is permitting the first application to reboot the device,
the resource is a monitoring of an SMS message received by the device and a recordal or processing on the SMS message and the run-time access permission is permitting the first application to monitor the SMS message and to record or perform processing on the SMS message,
the resource is recording audio on the device and the run-time access permission is permitting the first application to record audio on the device,
the resource is a sending of an SMS message using the device and the run-time access permission is permitting the first application to perform the sending of the SMS message,
the resource is a device system time and the run-time access permission is permitting the first application to set the device system time,
the resource is a device system time zone and the run-time access permission is permitting the first application to set the device system time zone,
the resource is a device wallpaper displayed by the device and the run-time access permission is permitting the first application to set the device wallpaper,
the resource is a vibrator associated with the device and the run-time access permission is permitting the first application to access or activate the vibrator,
the resource is a user's calendar data on the device and the run-time access permission is permitting the first application to write to the user's calendar data,
the resource is a user's contacts data on the device and the run-time access permission is permitting the first application to write to the user's contacts data,
the resource is writing to a storage that is external to the device and the run-time access permission is permitting the first application to write to the external storage,
the resource is a user's browsing history or bookmarks on the device and the run-time access permission is permitting the first application to write to the user's browsing history or bookmarks, or
the resource is an SMS message and the run-time access permission is permitting the first application to write the SMS message.

10. A central device comprising:
one or more processing units;
a memory, coupled to at least one of the one or more processing units, the memory storing:
a permissions management module, the permissions management module having electronic access to a plurality of information stores,
each respective information store in the plurality of information stores corresponding to a remote device in a plurality of remote devices,
each respective information store in the plurality of information stores comprising a corresponding plurality of permissions associated with the corresponding remote device, each permission in the corresponding plurality of permissions associated with a corresponding resource in a plurality of resources associated with the corresponding remote device, wherein the respective information store specifies, for each respective resource in the corresponding plurality of resources, which applications in a plurality of applications installed on the corresponding remote device have run-time access permission to use the respective resource;
the memory further comprising instructions that are executed by at least one of the one or more processing units, the instructions comprising instructions for:
(A) establishing an electronic communication with a first remote device in the plurality of remote devices; and
(B) making electronically available all or a portion of the information store in the plurality of information stores that is associated with the first remote device to the first remote device so that, when a first application is run on the first remote device, the information store enforces a run-time permissions policy that determines which resources on the first remote device may be accessed by the first application at run-time and permits the first application to continue running when the first application is denied a first resource on the basis that the run-time permissions policy did not grant the first application run-time permission to use the first resource.

11. The central device of claim 10, wherein the information store that is associated with the first remote device comprises a plurality of rules, each rule in the plurality of rules corresponding to a resource in a plurality of resources associated with the first remote device, and each respective rule in the plurality of rules specifying which applications in a plurality of applications installed on the first remote device has run-time access to the resource corresponding to the respective rule.

12. The central device of claim 10 wherein the first remote device is a hand-held device.

13. The central device of claim 10 wherein the data store is stored in the memory.

14. The central device of claim 10 wherein the making electronically available all or a portion of the information store in the plurality of information stores that is associated with the first remote device to the first remote device comprises sending the information store over a wireless connection from the central device to the first remote device.

15. The central device of claim 10 wherein the first remote device is operated under the Android operating system.

16. The central device of claim 10, wherein
a first information store in the plurality of information stores comprises a first plurality of run-time permissions associated with a first remote device, and
a second information store in the plurality of information stores comprises a second plurality of run-time permissions associated with a second remote device, wherein
the first plurality of run-time permissions is different than the second plurality of run-time permissions.

17. The central device of claim 10, wherein
the first resource is access to information about a network associated with the first remote device and the run-time permissions policy includes run-time permission to allow or disallow the first application to access the information about the network,
the first resource is access to information about a Wi-Fi network that is electronically accessible by the first remote device and the run-time permissions policy includes run-time permission to allow or disallow the first application to access the information about the Wi-Fi network,
the first resource is a battery statistic for a battery powering the first remote device and the run-time permissions policy includes run-time permission to allow or disallow the first application to collect the battery statistic,
the first resource is a connecting to a bluetooth device paired with the first remote device and the run-time permissions policy includes run-time permission to allow or disallow the first application to perform the connecting,
the first resource is discovering and pairing a bluetooth device with the first remote device and the run-time permissions policy includes run-time permission to allow or disallow the first application to perform the discovering and pairing,
the first resource is a broadcast by the first remote device of an SMS receipt notification and the run-time permissions policy includes run-time permission to allow or disallow the first application to perform the broadcast,
the first resource is a camera associated with the first remote device and the run-time permissions policy includes run-time permission to allow or disallow the first application access the camera,
the first resource is a modification of a current configuration of the first remote device and the run-time permissions policy includes run-time permission to allow or disallow the first application to make the modification,
the first resource is a change in a network connectivity state and the run-time permissions policy includes run-time permission to allow or disallow the first application to make the change,
the first resource is entering a Wi-Fi Multicast mode and the run-time permissions policy includes run-time permission to allow or disallow the first application to enter the Wi-Fi Multicast mode,
the first resource is a change of a Wi-Fi connectivity state of the first remote device and the run-time permissions policy includes run-time permission to allow or disallow the first application to make the change in the Wi-Fi connectivity state,
the first resource is a cache of an application installed on the first remote device and the run-time permissions policy includes run-time permission to allow or disallow the first application to clear the cache,
the first resource is user data on the first remote device and the run-time permissions policy includes run-time permission to allow or disallow the first application to clear the user data,
the first resource is one or more location update notifications from the radio associated with the first remote device and the run-time permissions policy includes run-time permission to allow or disallow the first application to enable/disable the one or more location update notifications from the radio,
the first resource is cache file stored by the first remote device and the run-time permissions policy includes run-time permission to allow or disallow the first application to delete the cache file,
the first resource is a package installed on the first remote device and the run-time permissions policy includes run-time permission to allow or disallow the first application to delete the package,
the first resource is a device power management associated with the first remote device and the run-time permissions policy includes run-time permission to allow or disallow the first application low-level access to the device power management,
the first resource is a keyguard associated with the first remote device and the run-time permissions policy includes run-time permission to allow or disallow the first application to disable the keyguard,
the first resource is a status bar displayed by the first remote device and the run-time permissions policy includes run-time permission to allow or disallow the first application to expand or collapse the status bar on a display associated with the device,
the first resource a flashlight associated with the first remote device and the run-time permissions policy includes run-time permission to allow or disallow the first application to turn the flashlight on or off,
the first resource is determining the space used by a package installed on the first remote device and the run-time permissions policy includes run-time permission to allow or disallow the first application to find out the space used by the package, or
the first resource is information about a currently or recently running task including a thumbnail representation of the task and an activity the task is running, and the run-time permissions policy includes run-time permission to allow or disallow the first application to get the information about the currently or recently running task.

18. The central device of claim 10, wherein
the first resource is a package and the run-time permissions policy includes run-time permission to allow or disallow the first application to install the package on the first remote device,
the first resource is an opening or closing of a network socket using the first remote device and the run-time permissions policy includes run-time permission to allow or disallow the first application to open or close the network socket,
the first resource is a global audio setting associated with the first remote device and the run-time permissions policy includes run-time permission to allow or disallow the first application to modify the global audio setting,
the first resource is a formatting of a file system for removable storage associated with the first remote device and the run-time permissions policy includes run-time permission to allow or disallow the first application to perform the formatting,
the first resource is a mounting or an unmounting of a file system for a removable storage system associated with the first remote device, and the run-time permissions policy includes run-time permission to allow or disallow the first application to perform the mounting or the unmounting,
the first resource is a monitoring, a modification, or an aborting of an outgoing call from the first remote device and the run-time permissions policy includes run-time permission to allow or disallow the first application to perform the monitoring, modification, or aborting of the outgoing call,
the first resource is a user's calendar data on the first remote device and the run-time permissions policy includes run-time permission to allow or disallow the first application to read the user's calendar data,
the first resource is a user's contacts data and the run-time permissions policy includes run-time permission to allow or disallow the first application read access to the user's contacts data,
the first resource is an SMS message received by the first remote device and the run-time permissions policy includes run-time permission to allow or disallow the first application read access to the SMS message,
the first resource is a reboot of the first remote device and the run-time permissions policy includes run-time permission to allow or disallow the first application to reboot the first remote device,
the first resource is a monitoring of an SMS message received by the first remote device and a recordal or processing on the SMS message and the run-time permissions policy includes run-time permission to allow or disallow the first application to monitor the SMS message and to record or perform processing on the SMS message,
the first resource is recording audio on the first remote device and the run-time permissions policy includes run-time permission to allow or disallow the first application to record audio on the first remote device,
the first resource is a sending of an SMS message using the first remote device and the run-time permissions policy includes run-time permission to allow or disallow the first application to perform the sending of the SMS message,
the first resource is a device system time of the first remote device and the run-time permissions policy includes run-time permission to allow or disallow the first application to set the device system time,
the first resource is a device system time zone of the first remote device and the run-time permissions policy includes run-time permission to allow or disallow the first application to set the device system time zone,
the first resource is a device wallpaper displayed by the first remote device and the run-time permissions policy includes run-time permission to allow or disallow the first application to set the device wallpaper,
the first resource is a vibrator associated with the first remote device and the run-time permissions policy includes run-time permission to allow or disallow the first application to access or activate the vibrator,
the first resource is a user's calendar data on the first remote device and the run-time permissions policy includes run-time permission to allow or disallow the first application to write to the user's calendar data,
the first resource is a user's contacts data on the first remote device and the run-time permissions policy includes run-time permission to allow or disallow the first application to write to the user's contacts data,
the first resource is writing to a storage that is external to the first remote device and the run-time permissions policy includes run-time permission to allow or disallow the first application to write to the external storage,
the first resource is a user's browsing history or bookmarks on the first remote device and the run-time permissions policy includes run-time permission to allow or disallow the first application to write to the user's browsing history or bookmarks, or
the first resource is an SMS message and the run-time permissions policy includes run-time permission to allow or disallow the first application to write the SMS message.

19. A method comprising:
(A) forming a catalog of resources requested by a first application thereby installing the first application on a device;
(B) installing a permissions application on the device, the permissions application having electronic access to an information store that comprises a plurality of permissions, each permission in the plurality of permissions associated with a corresponding resource in a plurality of resources associated with the device, wherein the information store specifies, for each respective resource in the plurality of resources, which applications in a plurality of applications installed on the device have run-time access permission to use the respective resource, the plurality of applications including the first application;
(C) executing the first application on the device;
(D) receiving a request for a resource in the catalog of resources from the first application while the first application is executing on the device; and
(E) using, responsive to the request, the permissions application and the information store to determine whether the first application has a run-time access permission to use the resource, wherein,
when the first application has the run-time access permission to use the resource, the first application is granted run-time access to the resource; and
when the first application does not have the run-time access permission to use the resource, the first application is not granted run-time access to the resource and the first application is permitted to continue to execute on the device without run-time access to the requested resource.

20. The method of claim 19 wherein the information store comprises a plurality of rules, each rule in the plurality of rules corresponding to resource in the plurality of resources and a permission in the plurality of permissions, and each respective rule in the plurality of rules specifying which applications in the plurality of installed applications has run-time access to the resource corresponding to the respective rule.

21. The method of claim 19 wherein the device is a hand-held device.

22. The method of claim 19, the method further comprising receiving, at the device, the information store from a remote resource policy administrator at a time prior to said executing (C).

23. The method of claim 19, the method further comprising wirelessly receiving, at the device, the information store from a remote resource policy administrator at a time prior to said executing (C).

24. The method of claim 19 wherein the forming (A), installing (B), executing (C), receiving (D), and using (E) are performed under the Android operating system.

25. The method of claim 19, wherein
the resource is access to information about a network associated with the device and the run-time access permission is allowing the first application to access the information about the network,
the resource is access to information about a Wi-Fi network that is electronically accessible by the device and the run-time access permission is allowing the first application to access the information about the Wi-Fi network,
the resource is a battery statistic for a battery powering the device and the run-time access permission is allowing the first application to collect the battery statistic,
the resource is a connecting to a bluetooth device paired with the device and the run-time access permission is allowing the first application to perform the connecting,
the resource is discovering and pairing a bluetooth device with the device and the run-time access permission is allowing the first application to perform the discovering and pairing,
the resource is a broadcast by the device of an SMS receipt notification and the run-time access permission is allowing the first application to perform the broadcast,
the resource is a camera associated with the device and the run-time access permission is allowing the first application access the camera,
the resource is a modification of a current configuration of the device and the run-time access permission is allowing the first application to make the modification,
the resource is a change in a network connectivity state and the run-time access permission is allowing the first application to make the change,
the resource is entering a Wi-Fi Multicast mode and the run-time access permission is allowing the first application to enter the Wi-Fi Multicast mode,
the resource is a change of a Wi-Fi connectivity state of the device and the run-time access permission is allowing the first application to make the change in the Wi-Fi connectivity state,
the resource is a cache of an application installed on the device and the run-time access permission is allowing the first application to clear the cache,
the resource is user data on the device and the run-time access permission is allowing the first application to clear the user data,
the resource is one or more location update notifications from the radio associated with the device and the run-time access permission is allowing the first application to enable/disable the one or more location update notifications from the radio,
the resource is cache file stored by the device and the run-time access permission is allowing the first application to delete the cache file,
the resource is a package installed on the device and the run-time access permission is allowing the first application to delete the package,
the resource is a device power management associated with the device and the run-time access permission is allowing the first application low-level access to the device power management,
the resource is a keyguard associated with the device and the run-time access permission is allowing the first application to disable the keyguard,
the resource is a status bar displayed by the device and the run-time access permission is allowing the first application to expand or collapse the status bar on a display associated with the device,
the resource a flashlight associated with the device and the run-time access permission is allowing the first application to turn the flashlight on or off,
the resource is determining the space used by a package installed on the device and the run-time access permission is allowing the first application to find out the space used by the package, or
the resource is information about a currently or recently running task including a thumbnail representation of the task and an activity the task is running, and the run-time access permission is allowing the first application to get the information about the currently or recently running task.

26. The method of claim 19, wherein
the resource is a package and the run-time access permission is allowing the first application to install the package on the device,
the resource is an opening or closing of a network socket using the device and the run-time access permission is allowing the first application to open or close the network socket,
the resource is a global audio setting associated with the device and the run-time access permission is allowing the first application to modify the global audio setting,
the resource is a formatting of a file system for removable storage associated with the device and the run-time access permission is allowing the first application to perform the formatting,
the resource is a mounting or an unmounting of a file system for a removable storage system associated with the device, and the run-time access permission is allowing the first application to perform the mounting or the unmounting,
the resource is a monitoring, a modification, or an aborting of an outgoing call from the device and the run-time access permission is allowing the first application to perform the monitoring, modification, or aborting of the outgoing call,
the resource is a user's calendar data on the device and the run-time access permission is granting the first application read access to the user's calendar data,
the resource is a user's contacts data and the run-time access permission is allowing the first application read access to the user's contacts data,
the resource is an SMS message received by the device and the run-time access permission is allowing the first application read access to the SMS message,
the resource is a reboot of the device and the run-time access permission is allowing the first application to reboot the device,
the resource is a monitoring of an SMS message received by the device and a recordal or processing on the SMS message and the run-time access permission is allowing the first application to monitor the SMS message and to record or perform processing on the SMS message,
the resource is recording audio on the device and the run-time access permission is allowing the first application to record audio on the device,
the resource is a sending of an SMS message using the device and the run-time access permission is allowing the first application to perform the sending of the SMS message,
the resource is a device system time and the run-time access permission is allowing the first application to set the device system time,
the resource is a device system time zone and the run-time access permission is allowing the first application to set the device system time zone,
the resource is a device wallpaper displayed by the device and the run-time access permission is allowing the first application to set the device wallpaper,
the resource is a vibrator associated with the device and the run-time access permission is allowing the first application to access or activate the vibrator,
the resource is a user's calendar data on the device and the run-time access permission is allowing the first application to write to the user's calendar data,
the resource is a user's contacts data on the device and the run-time access permission is allowing the first application to write to the user's contacts data,
the resource is writing to a storage that is external to the device and the run-time access permission is allowing the first application to write to the external storage,
the resource is a user's browsing history or bookmarks on the device and the run-time access permission is allowing the first application to write to the user's browsing history or bookmarks, or
the resource is an SMS message and the run-time access permission is allowing the first application to write the SMS message.

27. A method comprising:
(A) installing a permissions management module on a central device, the permissions management module having electronic access to a plurality of information stores,
each respective information store in the plurality of information stores corresponding to a remote device in a plurality of remote devices,
each respective information store in the plurality of information stores comprising a corresponding plurality of permissions associated with the remote device corresponding to the respective information store, each permission in the corresponding plurality of permissions associated with a corresponding resource in a plurality of resources associated with the remote device corresponding to the respective information store, wherein the respective information store specifies, for each respective resource in the corresponding plurality of resources, which applications in a plurality of applications installed on the remote device corresponding to the respective information store have run-time access permission to use the respective resource;
(B) establishing an electronic communication with a first remote device in the plurality of remote devices; and
(C) making electronically available all or a portion of the information store in the plurality of information stores that is associated with the first remote device to the first remote device so that, when a first application is run on the first remote device, a run-time permissions policy is enforced, the run-time permissions policy determining which resources on the first remote device may be accessed by the first application at run-time and permits the first application to continue running when the first application is denied a resource on the basis that the run-time permissions policy did not grant the first application run-time permission to the resource.

28. The method of claim 27 wherein the information store that is associated with the first remote device comprises a plurality of rules, each rule in the plurality of rules corresponding to a resource in a plurality of resources associated with the first remote device, and each respective rule in the plurality of rules specifying which applications in a plurality of installed applications installed on the first remote device has run-time access to the resource corresponding to the respective rule.

29. The method of claim 27 wherein the first remote device is a hand-held device.

30. The method of claim 27 wherein the making electronically available (C) comprises sending the information store over a wireless connection from the central device to the first remote device.

31. The method of claim 27 wherein the first remote device is operated under the Android operating system.
